(19) United States
(12) Patent Application Publication
(10) Pub. No.: US 2015/0258418 A1
(43) Pub. Date: Sep. 17, 2015

(54) Method and Apparatus for Playing a Card Game

(71) Applicant: New Buck, S.L., Valencia (ES)

(72) Inventor: Victor Pons Roger, Valencia (ES)

(73) Assignee: New Buck, S.L., Valencia (ES)

(21) Appl. No.: 14/216,367

(22) Filed: Mar. 17, 2014

(51) Int. Cl. A63F 1/00; G07F 17/32

(52) U.S. Cl. CPC A63F 1/00; G07F 17/3293; A63F 2001/0441

(57) ABSTRACT

Disclosed is a card game that may be played either physically or virtually. When played with two players, a first playing card set is dealt to a first player and a second playing card set is dealt to a second player. Each playing card set contains six playing cards, having the values 0, 1, 1, 2, 3 and 5. A secondary card set is also dealt onto the table, physically or virtually, which contains secondary cards having as a value of Nothing, One Winner, or Guess. Each player plays a particular card from their respective playing card set, governed by the rules that the highest value card played wins, with the exception that 0 defeats 5. A secondary card is then revealed, which depending on its face value may alter the value of the playing cards or require each player to guess the value of the playing card played by the opposing player. A winner is determined by applying the first set of rules regarding playing cards as modified by the second set of rules regarding secondary cards.

### FIELD OF THE DISCLOSURE

The subject matter of the present disclosure generally relates to determining the winner of a card game, and more particularly relates to a method of determining the winner of a card game in which each player has an identical set of cards, which are played in conjunction with a second set of cards.

### BACKGROUND OF THE DISCLOSURE

Numerous card games and other games of chance are well known. Furthermore, their implementation on electronic systems, such as machines located in casinos or operated between users connected through the Internet, are similarly well documented.

For example, U.S. Pat. No. 8,535,137, titled “Card Game Methods and Computer-Readable Medium for a Card Game Incorporating Scatter Awards” by Jay B. Stone, discloses a card game that may be implemented on an electronic device. U.S. Pat. No. 8,511,687, titled “Method of and Apparatus for Playing a Card Game” by Julian J. Kennedy, discloses an electronic video card game apparatus. The disclosures of U.S. Pat. Nos. 8,535,137 and 8,511,687 are hereby incorporated herein in their entirety.

However, many card games remained limited in the excitement that can be created in users, the retention of players, and the strategy necessary to play the game effectively. Some card games require no strategy, and are rather based solely on luck, which can be frustrating to many users.

The subject matter of the present disclosure is directed to overcoming, or at least reducing the effects of, one or more of the problems set forth above.

### BRIEF SUMMARY OF THE DISCLOSURE

Disclosed is card game, in which each player has an identical set of playing cards and there is a set of secondary cards that may, or may not alter the value of the playing cards during the course of a round. In an embodiment, two players each are dealt a set of playing cards, containing cards of certain values. The playing cards are governed by a first set of rules, which dictates an order of winning preference. Each player plays one of their playing cards, and cannot play it again for the remainder of the game. From a set of secondary cards formed according to specific rules, a secondary card is revealed, that is, chosen at random and presented to the players. The revealed Secondary Card may alter the meaning of the playing cards played by each respective player. A winner is determined by applying the set of rules governing the playing cards as modified by the set of rules governing the secondary cards. Several rounds of play may constitute a full game. In a typical game, consisting of six rounds, each player must play all of his Playing Cards.

The method is suitable for implementation as either a physical game involving cards or a board game, or as an electronic game presented on the display of an electronic device. For instance, players may use physical cards, connect over the internet, or play against a virtual “house” at a casino.

Optionally, players can bet after the players play their playing cards and again after the secondary card is revealed. Betting may be accomplished with coins or other currency. Variations of the game may be made so that new embodiments are created, thereby maintaining the interest of established players and attracting new players. For instance, various betting schemes can be introduced and additional players can be added.

In a certain preferred embodiments, the fanciful term “Scont” refers generally to the disclosed method, the fanciful term “Sconter” refers to a player of the game, the fanciful term “Scoint” refers to a coin collected by Sconters during their play, and the fanciful term “Eldest Hand” refers to the player that is temporarily so designated and who enjoys certain preferences, such as the right to view certain played cards or to win a round in the case of a tie.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a schematic illustration of two electronic devices configured for two opposing players.

FIG. 2 is a flow chart diagram of an embodiment.

FIG. 3A is an illustration of virtual cards as seen on the display of an electronic device and used in performing an embodiment.

FIG. 3B is an illustration of virtual guessing cards as seen on the display of an electronic device and used in performing an embodiment.

FIG. 4A is an illustration of a virtual anti-tie table for use with a three player embodiment.

FIG. 4B is an illustration of a virtual anti-tie table for use with a four player embodiment.

FIG. 5 is an illustration of an ongoing first embodiment game as seen on the display of an electronic device.

FIG. 6 is an illustration of an ongoing second embodiment game as seen on the display of an electronic device.

FIG. 7 is an illustration of a home screen for use with embodiment games as seen on the display of an electronic device.

FIG. 8A is an illustration of avatars for use by players engaged in an embodiment.

FIG. 8B is an illustration of a logo for use in a preferred embodiment.

FIG. 8C is an illustration of an icon for use in a preferred embodiment.

Like reference numbers and designations in the various drawings indicate like elements. In the drawings, various shape-fill patterns indicate differing colors. For instance, horizontal waves may indicate the color red, horizontal dashed lines may indicate the color blue, vertical dashed lines may indicate the color red, angled checkering may indicate the color yellow, dotting may indicate the color brown, and angled dashed lines may indicate the color gold.

### DETAILED DESCRIPTION

Disclosed is a method of determining a winner of a card game, which may be implemented either as a physical card game or as a virtual card game using electronic equipment.

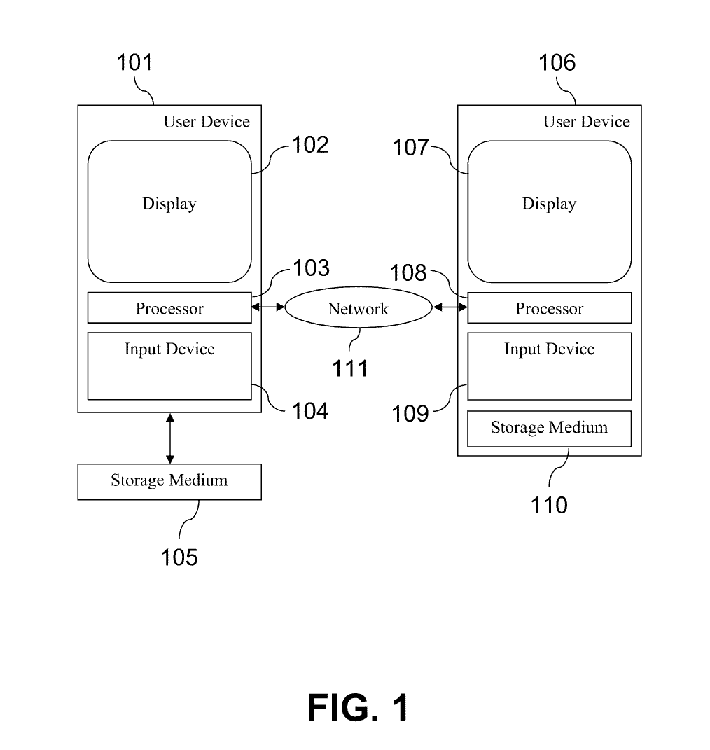

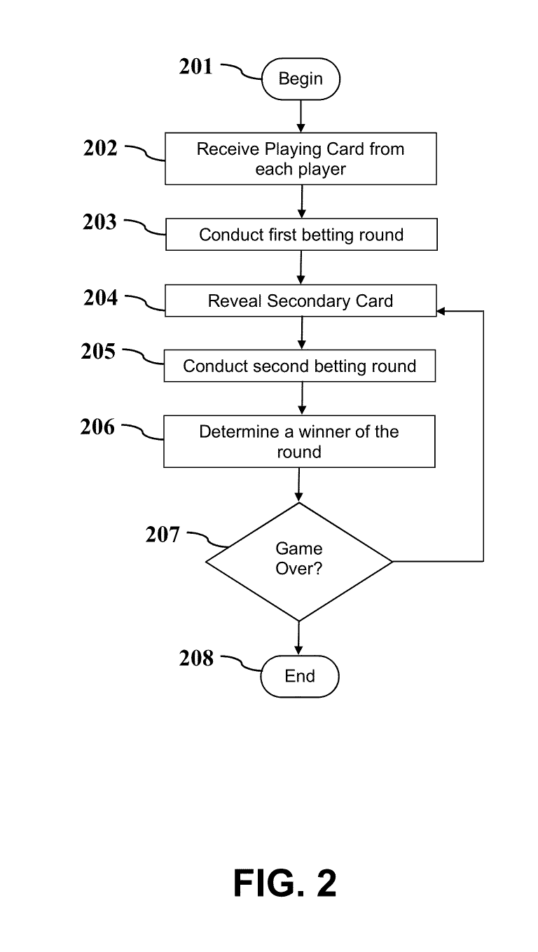

FIG. 1 is a schematic of an electronic device for use with certain electronic embodiments of the disclosure. First user device 101 has display 102, processor 103 and input device 104, and is connected to a remote non-transient computer-readable digital storage medium 105. Second user device 106 has display 107, processor 108, input device 109 and digital storage medium 110. User device 101 is connected to user device 106 through network 111. Those of skill in the art to which the present application pertains will understand that there are many electronic devices and designs suitable for use with the disclosed method. There exists many suitable digital storage medium setups. For instance, digital storage mediums may have multiple segments, or may be remote from the user device. Similarly, many suitable displays exist and user input may be received through any suitable means, including without limitation computer mice, keyboards, touch screens, voice activation, etc.

In certain embodiments, coins can be used as betting currency, and betting can occur after the Playing Cards are received and before the Secondary Card is revealed, which are referred to as a first and second betting round, respectively.

In step 201, a first Playing Card Set is provided to a first player and a second Playing Card Set is provided to a second player, each Playing Card Set containing six Playing Cards, having the values 0, 1, 1, 2, 3 and 5. Also provided is a Secondary Card Set containing six Secondary Cards, each of the Secondary Cards having a value of Nothing, One Winner, and Guess.

In step 202, one of the Playing Cards from each of the first and second Playing Card Sets is received. Receipt can follow the selection of a Playing Card by the player (or election of a Playing Card via a user interface in electronic embodiments) or alternatively a card can be automatically selected for the user at the expiration of a pre-specified amount of time. Playing Cards can only be played once during a game, which consists of six rounds. In step 203, a first betting round is conducted, with the Eldest Hand betting first. In step 204, a Secondary Card from the Secondary Card Set is revealed to the players. In step 205, a second betting round is conducted.

The Playing Cards are governed by a first set of rules, whereby the highest value Playing Card is the winning card, except that 0 defeats 5. The Secondary Cards are governed by a second set of rules. A Nothing card indicates that nothing happens to the values of the received Playing Cards. A One Winner card indicates that any one of the received Playing Cards having a value of 1 is considered to have the highest value of the received Playing Cards. A Guess card indicates each player must guess the value of the Playing Card received from the other player.

In step 206, the winner of the round is determined by applying the first set of rules as modified by the second set of rules, including, if a Guess card is revealed, a first guess input from the first player and a second guess input from the second player. The winner of the round wins the bets that were placed during the first and second betting round. In step 207, if the round just completed is not the last round (i.e., there are Playing Cards yet to be played) steps 202-206 are repeated until the game is complete, that is each of the Playing Cards has been played. Once each of the Playing Cards has been played, the game ends in step 208, and all of the cards are revealed as they were played to verify the game's outcomes to the players.

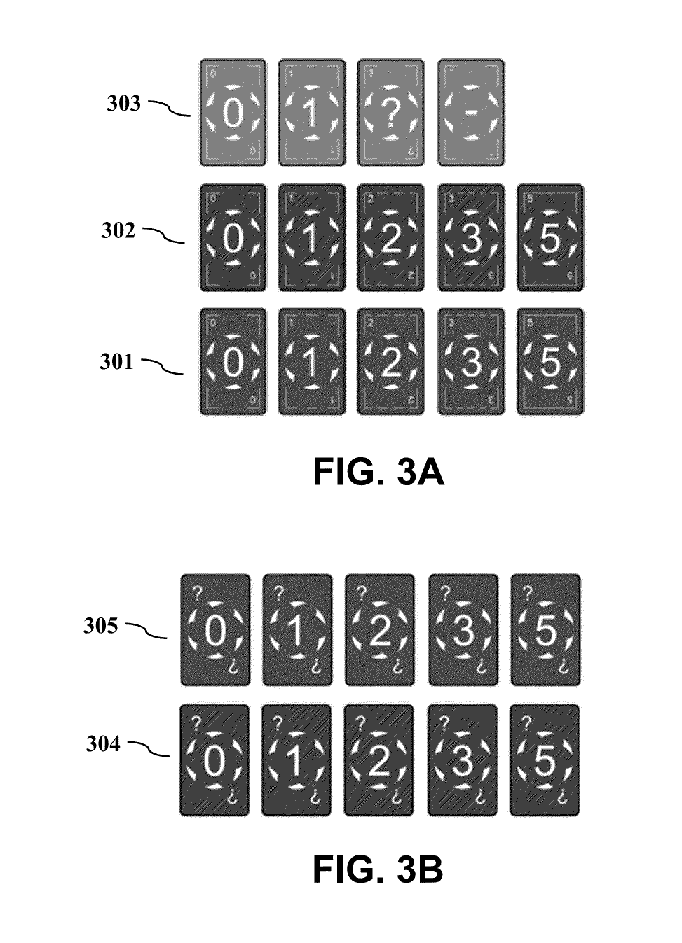

FIG. 3A is an illustration of virtual Playing Cards 301 that have a first color (associated with a first player), Playing Cards 302 that have a second color (associated with a second player), and Guesses cards 303 that have a third color. FIG. 3B is an illustration of virtual guessing cards, in which first set of guessing cards 304 has a first color corresponding to first Playing Card Set 301, and second set of guessing cards 305 has a second color corresponding to second Playing Card Set 302.

In a preferred embodiment, the method is a game referred to as Scont. There are two players, each with the same six cards, referred to as Playing Cards, which have the values of 0, 1, 1, 2, 3 and 5. The player that starts the round is referred to as the Eldest hand and has Playing Cards that are blue in color. The player that is not the Eldest hand has playing cards that are red in color. The different colors of the Playing Cards, while optional, allows the convenient identification of the Eldeset Hand. The Eldest Hand can also be identified using a particular coin which is placed in front of the Eldest Hand.

In each complete round, each player must play one of their six Playing Cards. To do this, they must choose a card from among their remaining cards and place it face down in the center of the board so that the opponent cannot see which card it is. It should be noted that only one Playing Card can be played in each round by each player and thereafter it cannot be used during the rest of the game. A first betting round is conducted after each player deposits one of their Playing Cards.

Next, a Secondary Card is revealed from a Secondary Card Set having Secondary Cards. There are three types of Secondary Cards, including “Nothing,” “One Winner,” and “Guess” cards. The value of the Secondary Cards may or may not alter the outcome that would otherwise be produced by the Playing Cards. A Nothing card indicates that nothing is to happen, that is, the value of the Playing Cards will remain unchanged. A “One Winner” card indicates that if any player played a one 1 card, that card will be come the card with the card with the highest value on the table, that is, the winning card. If both players played a one 1 card and the “One Winner” card is revealed, the Eldest Hand wins the round. A “Guess” card indicates that the players must guess the card played by their opponent. If only one of the Sconters correctly guesses the value of the Playing Card of their opponent, that Sconter wins the round. If both Sconters either correctly or incorrectly guess the value of the other Sconter's Playing Card, the value of the Playing Cards remains unaltered. After the Secondary Card is revealed, a second betting round is conducted, prior to the revelation of the Playing Cards to the Eldest Hand (as required), which is kept face down during the round. In certain embodiments, only the Eldeset Hand will be able to view both player's Playing Cards at the end of the round.

Following the completion of the second betting round, the winner is determined by the rule that the Playing Card with the highest value wins, except that 0 defeats 5. However, this rule is modified according to the outcome dictated by the value of the Secondary Card. For instance, if one Sconter were to play a 1 Playing Card, the other Sconter were to play a 5 Playing Card, and the Secondary Card was a Nothing card, the Sconter who played the 5 Playing Card would be the winner of the round. However, if a One Winner card was revealed, the Sconter who played the 1 Playing Card would be the winner. Thus, the prospective chances of a Sconter to win a round is dynamic through the complete round and based on a number of factors, including the choice of Playing Card value, the partly predictable but still somewhat random value of the Secondary Card, reading the meaning of bets made by the opposing player, etc. Furthermore, a Sconter must strategize the use of their limited number of Playing Cards: for instance, a 5 card creates a strong chance of success, but can only be used once over the course of the game. If the other player played a 2 card, and a Nothing card was revealed, the player would have been better off playing a 3 card in that particular round, as they would still have won the round without expending their valuable 5 card which could be used to beat, for instance, a 3 card played by the opposing player in a subsequent round.

There are as many Secondary Cards as there are Playing Cards, so that there is always one Secondary Card revealed in each round of play. However, the frequency of the types of Secondary Cards is variable. In the embodiment, the Secondary Card Set always includes three Nothing cards, one One Winner card, and one Guess card. However, the remaining card may be any of the three types (Nothing, One Winner, or Guess), and is selected at random without the players' knowledge as to is the card's type.

If Scont is being played with physical cards, the procedure to select the random card is as follows. A Nothing card, a One Winner card and a Guess card are selected and shuffled. One is selected randomly without looking at the cards and it is added to the set. The deck is then deliberately shuffled again, finally leaving the deck face down in the middle of the table.

Therefore, the Secondary Card Set will vary between games and the Secondary Cards that are revealed will be revealed in different orders. If Scont is played on a computer program, selection of the Secondary Cards is made automatically.

During the first four rounds, the Eldest Hand will have the right to see his opponent's Playing Card. The Eldest Hand designation switches each time there is a new round. In other words, during the first and the third round, the player with the Blue Cards—the Eldest Hand—will see his opponents' cards. During the second and fourth round, the player with the Red Cards, who will be the Eldest Hand then, will see his opponents' cards. If the Eldest Hand folds, he is not allowed to see the cards.

If any of the players, no matter who, folds before the Secondary Card is revealed, the Playing Cards are not shown to the Eldest Hand and the Secondary Card is not shown to either player. In this scenario, the Secondary Card is taken from the Secondary Card Set but is not revealed until the end of the game.

Generally, the played cards are ordered so that the whole game is clearly recorded by the end of it. This means that once the second betting round is over and after showing the cards to the Eldest Hand (if necessary), the cards are ordered in such a way that the Secondary Card is the last one and it is face down. On top of it there is the Playing Card of the one who is not the Eldest Hand and on top of that there is the Eldest Hand's Playing Card.

In an alternate embodiment, if the game is played with coins (or “Scoints), at the beginning of each round, the player who is losing can reintroduce coins to call his opponent's bet. However, the reintroduction of coins can only be made by the player who is losing and only then within a limit, so that the player will not be able to surpass the number of coins of his opponent. At the end of a round where a Guess card has been revealed, every player will be informed whether or not they have guessed. In physical iterations of the game, the Eldest Hand announces the winner of each round. For the fifth round, in which ideally neither player sees the played cards, a third-party reviews the cards and announces the winner, though the Eldest Hand can also perform this task.

Betting can be accomplished as in other card games, in which players “bet,” “check,” or “raise.” Optionally, each of the six rounds requires each player to place a minimum bet. If a player leaves the game before it is over, he loses the minimum number of coins that are left (except when he has run out of coins and wants to fold, which he could do with no penalty).

Players can choose the amount of coins they want to introduce for each round and the minimum bet. Optionally, the minimum bet is a 2.5% of the total amount the game is started with. This means that if someone enters into a table with forty Scoints, the minimum bet is one, for a table with two hundred, the minimum bet is five, for a table with eight hundred, it is twenty, etc.

There exists many variations to the thus-far described embodiments, which will be understood by those of skill in the art to which the present disclosure relates to be encompassed by the claims of the present application.

In a “Blind” embodiment, neither payer is allowed to see the cards played by any opponent, regardless of their status as the Eldest Hand, and the cards are never shown.

In a “Half In” embodiment, a player can bet half of what the player with less Scoints has. In the embodiment, every player must go half in at least once or call a bet which is equal or higher than a Half In. If the player who has won more Scoints does not go Half In, he will not only not win those coins, but the same amount will also be taken from his own coins and another player will win them, as long as the latter has gone Half In. In the embodiment, nothing happens if none of the players have gone Half In. Another optional variation is to require players to go Half In twice, or three times or more in a particular game.

In still another variation, players are required to go All In during one or more rounds.

In an alternate embodiment referred to as One View, instead of showing the cards to the Eldest Hand during the four first rounds, they are shown to him only the first time he is the Eldest Hand, that is to say, they can only be seen during the first two rounds, which means that each player will see his opponent's cards only once.

In an alternate embodiment referred to as Scont Long, there are four consecutive games with only one Secondary Card Set, which has thirteen Nothing cards, six One Winner cards, six Guess cards and one “Two Winner” card, that if revealed, dictates that if any player has played a 2, that player wins. There are twenty-six Secondary Cards in total, so that two are not played.

In yet another alternate embodiment, a seventh Playing Card is added to the Playing Card Set, having a value of ½, that could only defeat a Playing Card having a value of 0.

It is possible to play the game with more than 2 players. For instance, Scont with three players has the same procedures as Scont with two players, with the addition of a player having a new set of Playing Cards, preferably of a new color (such as green). In the event one of the three players plays a 0, another played a 5, and another played a card other than either of these cards, the player who played the 0 wins, as the fact a 5 was played makes the 0 the highest valued card. This of course, assumes the Secondary Card that is revealed does not alter the game's outcome.

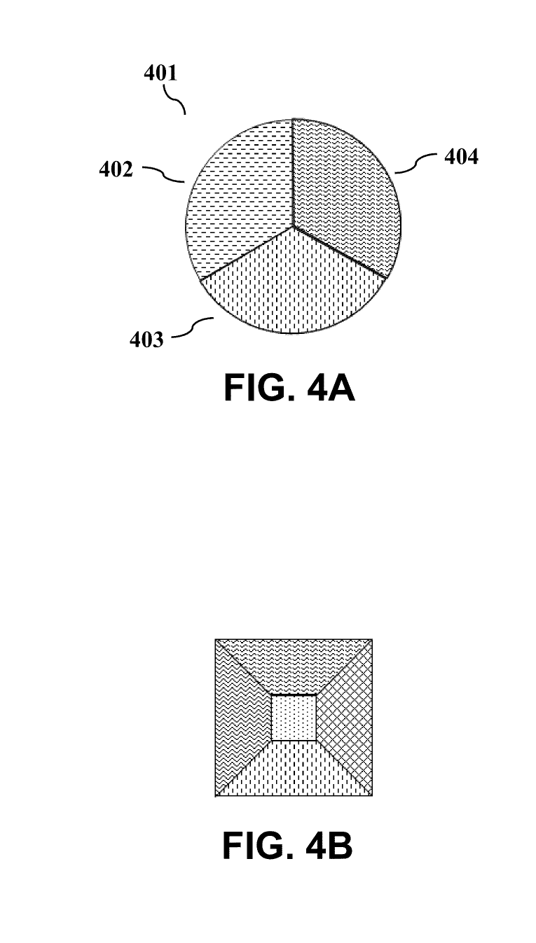

If one of the three players folds during the course of a round, the player's card will be treated as if it did not exist, that is, the round will continue between the remaining two players. Take for instance, the situation in which a Player A plays a 0, a Player B plays a 3, and a Player C plays a 5. If Player C folds, Player B is the winner (3 defeats 0, because 0 is no longer the card with the highest value since Player C folded). There are several ways in which to resolve the case where a tie exists between all three players. If there is a tie (two or all three players have played the same card), the Eldest Hand can be deemed the winner (if the tie happens between two of the players who are not the Eldest Hand, the one on the Eldest Hand's right wins). Alternatively, an anti-tie table can be used, as pictured in FIG. 4A, in which anti-tie table 401 has tiles 402, 403, and 404, each of which is a different color corresponding to a player with Playing Cards of matching color. For example, the Eldest Hand, (Player A (Blue)), places a 0, a 3 and a 5 on each of the colors of the table, which represent each of the players. In the example, Player A places a 0 on the Blue color, a 5 on the Red color and a 3 on the Green color. If there is a tie in the Playing Cards, it would be resolved in the following way. If there is a three-way tie, Player A (Blue) wins, as 0 becomes the card with the highest value in the anti-tie table because there is a 5. If there is a tie between Player A (Blue) and Player B (Red), Player A wins, as there is a 0 on the anti-tie table and it defeats the 5. If there is a tie between Player A and Player C, because the Blue player has a 0 and the Green player has a 3 on the anti-tie table, Player C (Green) wins. If there is a tie between Player B and Player C, Player B wins because 5 defeats 3. When an anti-tie table is employed, there is not an outright winner in the case of a tie, which adds complexity to the game and requires players to strategize.

In three player Scont, when players have to guess, they must try to guess the cards of their two opponents. The player who has the most correct guesses wins. For example, if a player guesses both other player's cards, they will win if the other players only each have one correct guess. If two players guess two cards correctly, the value of their Playing Cards is used to end the tie. If there is still a tie, an anti-tie table can be used, or alternatively status of who is the Eldest Hand can be used.

The disclosed game method could also be adapted for use with four or five players, similar to the three-person rules only using a rectangular shape table. FIG. 4B depicts an illustration of an top view of such a table.

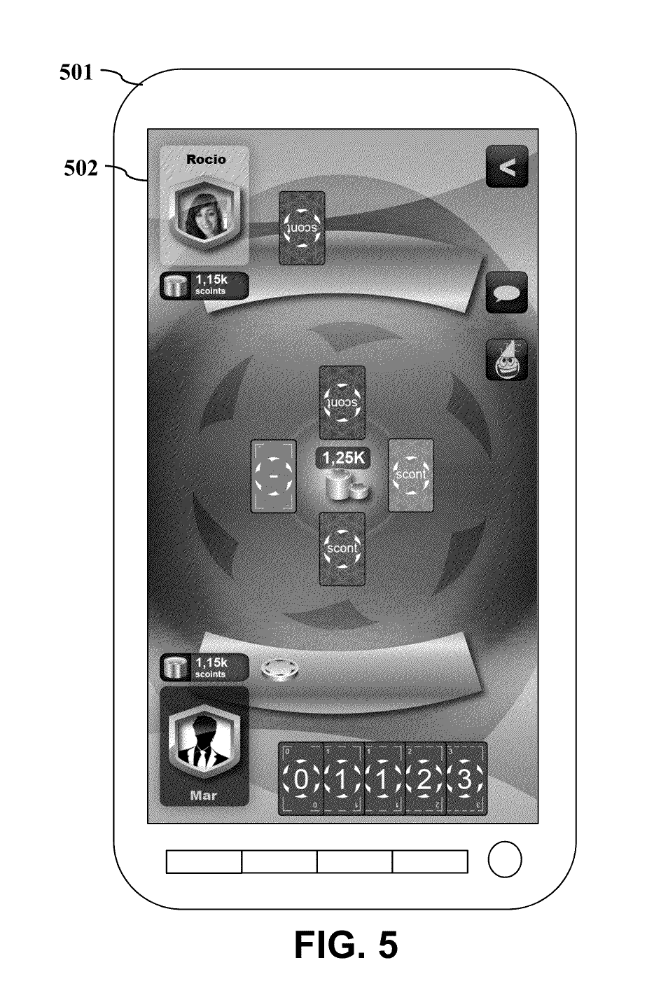

FIG. 5 depicts a Scont game being played on electronic device 501 through a depiction on display 502.

In another embodiment, the Secondary Cards include a 50% card, which, when revealed, requires players to engage in an extra betting round, after which a new Secondary Card is drawn from an additional deck in which there are only cards of the type One Winner and Guess.

In another alternate embodiment, the Secondary Cards are represented with a Die. After the first round of betting, the Eldest Hand rolls the die (a six-sided die) and if the Eldest Hand rolls a one, it is equivalent to the One Winner card. If he rolls a six, it is equivalent to the Guess card. If the Eldest Hand gets a three, it is equivalent to the 50% card (in other variants, the die is rolled again). Numbers two, four and five would be equivalent to the Nothing card. A special die with Scont symbols can be used, but also a normal die can be employed by giving these values to its numbers.

In a second preferred embodiment, referred to herein as Scont Duel, two consecutive games are played. The player who starts as the Eldest Hand is different for each of the two games. For instance, in the first game a player A will have Blue Cards and will be the Eldest Hand in the first Round, and in the second game, player A will have Red colored Playing Cards, and will be the Eldest Hand during the second, fourth and sixth rounds. The winner of Scont Duel takes all his opponent's initial coins and all the coins he has won. To be the winner of the Duel, a player must win more coins than his opponent over the two consecutive games. However, to be considered a winner in the embodiment, a player must also confront their opponent at least three times in each game. A Confrontation (can be indicated in an electronic version by an “E” or “C” counter) happens when a player does not fold, that is to say, when a player finishes a bet (even though the other player has folded). A Reasonable Fold (can be indicated in an electronic version by an “RR” or “RF” counter) happens when a player folds because the opponent has made a bet higher than a Half In. Four Reasonable Folds are counted as a Confrontation. If the player with more coins has not had enough Confrontations in each game, the other player wins and takes the opponent's initial coins and also recovers the coins he might have lost, which means that he wins everything.

If there is a tie in the winnings (at the end of the two consecutive games), it is solved first by looking at who has won more rounds, second by who won the most Scoints in a single round, and third by looking at the first one to win more Scoints in one round. In order to record the general gains, there is a counter that indicates the gains of each player. The player with the highest counter wins. Scont Duel is particularly well suited for use in tournament style play.

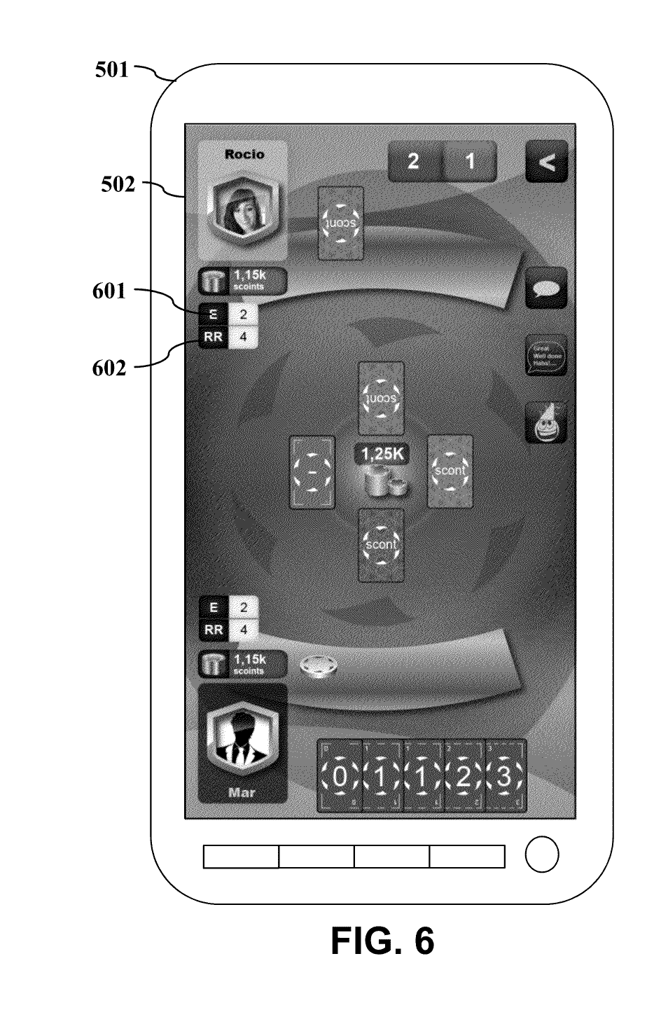

FIG. 6 depicts a Scont Duel game being played on electronic device 501, as depicted on display 502. Confrontation counter 601 tracks the number of confrontations made by a particular player, while Reasonable Fold counter 602 tracks the number of Reasonable Folds made by that player.

There are countless variants of Scont, as minor changes may be made to the disclosed embodiments. This means that players could even play Scont Duel-Half In-One View, which would be a variant mixing a Duel and requiring every player to go Half In in every game, and only allowing players to view their opponents' cards during the first time that they are the Eldest Hand.

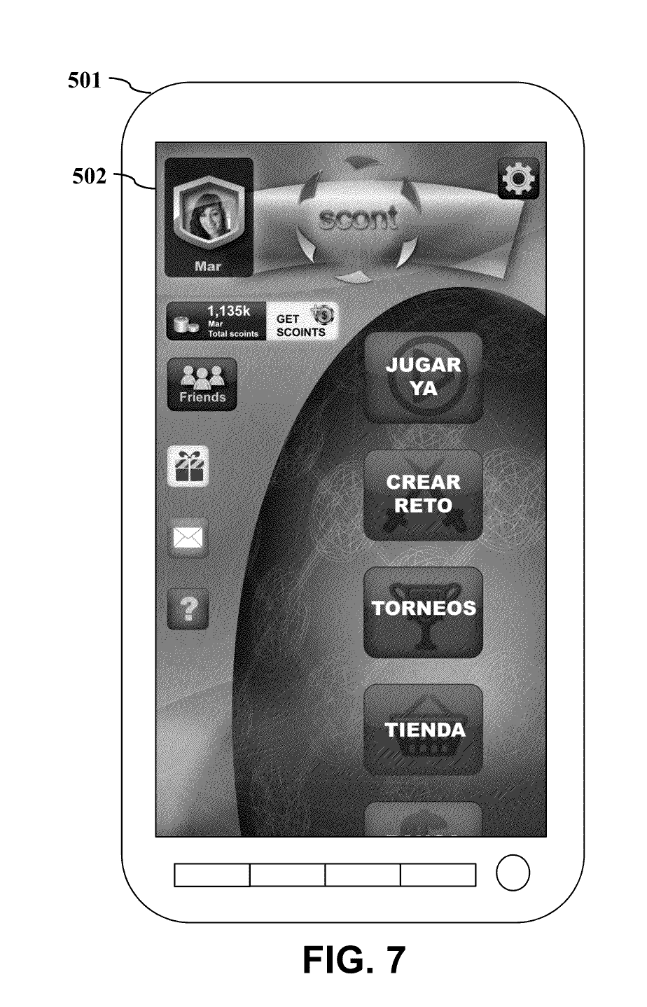

FIG. 7 displays a Scont main menu as depicted on display 502 of electronic device 501. From the main menu, players can select various game types, etc.

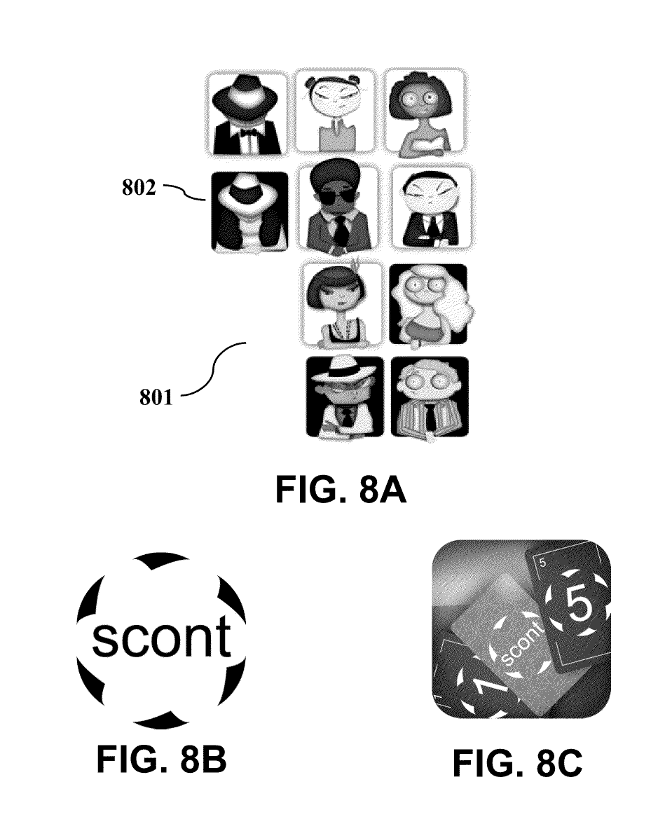

FIG. 8A is an illustration of “avatars” 801 for use with embodiments on electronic devices. The use of avatars allows players to personalize their game to their own desires, and identify characteristics about themselves to other players. For instance, a user can choose anonymous female avatar 802. FIG. 8B illustrates a logo for use with preferred embodiments. FIG. 8C illustrates a icon as seen on the display of an electronic device, which can, for instance, allow a user to access a virtual embodiment from a virtual desktop.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention. For instance, Scont could be played with eight cards, three rounds, with pairs, etc.

What is claimed:

1. A method for determining a winner for a card game, comprising the steps of:
(1) providing a first Playing Card Set to a first player and a second Playing Card Set to a second player, each Playing Card Set containing six Playing Cards, having the values 0, 1, 1, 2, 3 and 5;
(2) providing a Secondary Card Set containing six Secondary Cards, each of the Secondary Cards having one of a value of Nothing, One Winner, and Guess;
(3) receiving from the first player one of the Playing Cards of the first Playing Card Set and receiving from the second player one of the Playing Cards of the second Playing Card Set;
(4) revealing one of the Secondary Cards of the Secondary Card Set;
wherein the Playing Cards are governed by a first set of rules dictating that the highest value Playing Card of the received Playing Cards wins, except that 0 defeats 5;
wherein the Secondary Cards are governed by a second set of rules dictating that:
(a) a Nothing card indicates that nothing happens to the values of the received Playing Cards;
(b) a One Winner card indicates that any one of the received Playing Cards having a value of 1 is considered to have the highest value of the received Playing Cards;
(c) a Guess card indicates each player must guess the value of the Playing Card received from the other player;
(5) determining a winner of a round by applying the first set of rules as modified by the second set of rules, including, if a Guess card is revealed, a first guess input from the first player and a second guess input from the second player.

2. The method of claim 1 wherein:
the repetition of steps (3) through (5) five additional times constitutes a game; and
wherein each Playing Card may only be received once during the game.

3. The method of claim 2 wherein the Secondary Card Set contains three Nothing cards, one One Winner card, and one Guess card, and one Secondary Card of a type selected at random.

4. The method of claim 3 further comprising:
conducting a first betting round after step (3); and
conducting a second betting round after step (4).

5. The method of claim 4, wherein each player must make a Half In bet during at least one round of the game.

6. The method of claim 4, wherein each player must make an All In bet during at least one round of the game.

7. The method of claim 4, wherein
a third player is dealt a third Playing Card Set in step (2);
one of the Playing Cards of the third Playing Card Set is received from the third player in step (3); and
ties between the players are resolved using a tie table during the determination of step (5).

8. The method of claim 4, wherein:
a Duel is defined as two consecutively played games, the duel winner of which is the player with a highest value of earnings at the end of the two played games; and wherein each player must make a confrontation of the other player at least 3 times in each game, and four Reasonable Folds equate to one confrontation.

9. The method of claim 4, wherein a designation as the Eldest Hand switches between the players at the completion of each round, the player that is designated the Eldest Hand being able to view the cards of the opposing player at the completion of a round for a limited number of times during the game.

10. The method of claim 2, wherein the method is performed using an electronic device, and each player selects an avatar.

11. A gaming system, comprising:
an electronic device having a display, a processor, and an input device,
a non-transient computer-readable storage medium,
wherein the storage medium has encoded on it a set of executable instructions for a card game, that, when executed, causes the processor to:
present on the display the dealing of a first Playing Card Set to a first player and the dealing of a second Playing Card Set to a second player, each Playing Card Set containing six Playing Cards, having the values 0, 1, 1, 2, 3 and 5, and
present on the display the dealing of a Secondary Card Set containing six Secondary Cards, each of the Secondary Cards having one of a value of Nothing, One Winner, and Guess;
the input device being configured to receive from the first player an election of one of the Playing Cards of the first Playing Card Set and receive from the second player an election of one of the Playing Cards of the second Playing Card Set;
wherein the executable instructions, when executed, causes the processor to further:
reveal on the display one of the Secondary Cards of the Secondary Card Set;
wherein the Playing Cards are governed by a first set of rules encoded on the storage medium dictating that the highest value Playing Card of the received Playing Cards wins, except that 0 defeats 5;
wherein the Secondary Cards are governed by a second set of rules encoded on the storage medium dictating that:
(a) a Nothing card indicates that nothing happens to the values of the received Playing Cards;
(b) a One Winner card indicates that any one of the received Playing Card having a value of 1 is considered to have the highest value of the received Playing Cards;
(c) a Guess card indicates each player must guess the value of the Playing Card received from the other player;
the processor being configured to determine a winner of a round by applying the first set of rules as modified by the second set of rules, including, if a Guess card is revealed, a first guess input from the first player and a second guess input from the second player; and
the processor being further configured to present on the display the winner of the round.

12. The system of claim 11 wherein the electronic device is configured to receive additional elections of one Playing Card and revealing on the display one Secondary Card for each round, wherein a total of six rounds constitutes a game.

13. The system of claim 12 wherein the Secondary Card Set contains three Nothing cards, one One Winner card, and one Guess card, and one Secondary Card of a type selected at random by the processor.

14. The system of claim 13 further wherein the electronic device is configured, in each round, to conduct a first betting round after receiving an elected Playing Card from each of the players and is further configured to conduct a second betting round after revealing on the display one of the Secondary Cards of the Secondary Card Set.

15. The system of claim 14, wherein the executable instructions require each player to make a Half In bet during at least one round of the game.

16. The system of claim 14, wherein the executable instructions require each player to make an All In bet during at least one round of the game.

17. The system of claim 14, wherein
the executable instructions, when executed, cause to be presented on the display dealing of a third Playing Card Set to a third player; the input device is configured to receive an election of a Playing Card from a third player; and
the processor is configured to resolve ties between the players using a tie table encoded on the storage medium.

18. The system of claim 14, wherein:
a Duel is defined by two consecutively played games, the executable instructions dictating that each player must make a confrontation of the other player at least 3 times in each game with four Reasonable Folds equate to one confrontation, and
wherein a duel winner is determined by the processor as the player with a highest value of earnings at the end of the two played games.

19. The system of claim 14, wherein in each round a Eldest Hand designation switches between the players, and in a game the Eldest Hand is allowed to view the received Playing Card of the opposing player at the end of each round, for the first four rounds.

20. The system of claim 12, wherein the input device is configured to receive an election of an avatar for presentation on the display as a representation of one of the players.
